(19) United States
(12) Patent Application Publication
(10) Pub. No.: US 2024/0187885 A1
(43) Pub. Date: Jun. 6, 2024

(54) NETWORK USE OPTIMIZATION

(71) Applicant: Zimeno Inc., Livermore, CA (US)

(72) Inventors: Chandrashekar PABBISHETTY, Madhapur (IN); Sadasivudu MALLADI, San Jose, CA (US); Sudhakar ROMPICHARLA, Pragathi Nagar (IN); Jaswanth KOYA, Madhapur (IN)

(73) Assignee: Zimeno Inc., Livermore, CA (US)

(21) Appl. No.: 18/527,099

(22) Filed: Dec. 1, 2023

Related U.S. Application Data
(60) Provisional application No. 63/526,240, filed on Jul. 12, 2023.
(60) Provisional application No. 63/429,170, filed on Dec. 1, 2022.

(51) Int. Cl. H04W 24/02; H04L 43/0805; H04W 48/20

(52) U.S. Cl. CPC H04W 24/02; H04L 43/0805; H04W 48/20; H04W 84/12

(57) ABSTRACT

A network use optimization system may include a communication connection controller for being carried by a vehicle. The controller is configured to receive data signals from at least one data source, assign a data signal category to the data signals, and evaluate a current availability of each of a cellular data communications device and a radio frequency communications device. The controller is further configured to select one of the cellular data communications (CDC) device and the radio frequency communications (RFC) device for transmission of the data signals based on the current availability of each of the cellular data communications device and the radio frequency communications device and the category assigned to the data signals. The controller (1) outputs the selection to a person for confirmation and in response to a received confirmation, transmit the data signals using the selection or (2) automatically transmit the data signals using the selection.

### CROSS-REFERENCE TO RELATED PATENT APPLICATIONS

The present non-provisional application claims priority and benefit from co-pending U.S. provisional patent Application Ser. No. 63/429,170 filed on Dec. 1, 2022, by Sadasivudu Malladi and entitled NETWORK USE OPTIMIZATION, and co-pending U.S. provisional patent Application Ser. No. 63/526,240 filed on Jul. 12, 2023, by Kaushik et al. and entitled VEHICLE CONTROL, the full disclosures of which are hereby incorporated by reference.

### BACKGROUND

Data from vehicles is more frequently being transmitted to and from remote recipients. Such data transmissions may be used to monitor, record or remotely control operations or performance of the vehicle. Such data transmissions may be used to train a machine learning network for subsequent automation of such operations. Such data transmissions may be used to monitor, record or remotely control operations of attachments or implements connected to the vehicle. The overall amount or load of data transmissions may, in some circumstances, result in unsatisfactory transmission performance.

### BRIEF DESCRIPTION OF THE DRAWINGS

FIG. 1 is a diagram illustrating portions of an example network use optimization system.

FIG. 2 is a flow diagram of an example network use optimization method.

FIG. 3 is a flow diagram of an example network use optimization method.

FIG. 4 is a perspective view of an example network use optimization system provided as part of an example tractor.

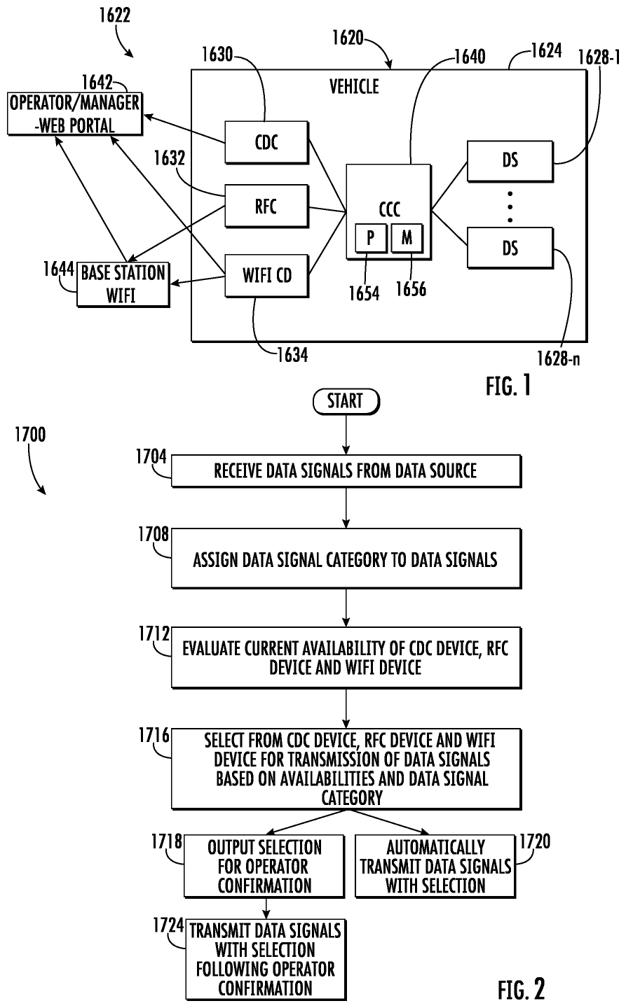

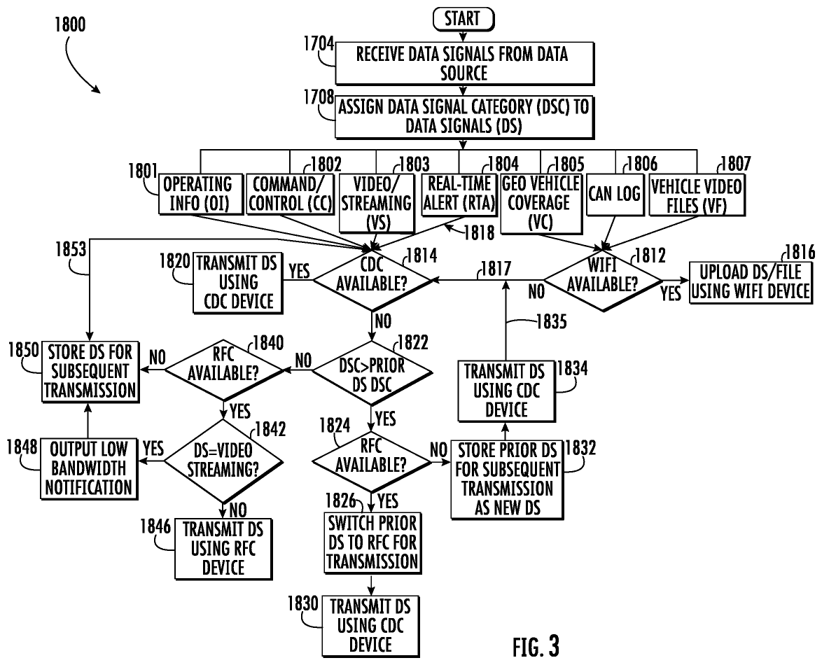

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example vehicles, network use optimization systems and network use optimization methods. The example vehicles, systems and methods automatically identify and select the most appropriate medium or communication device on a vehicle for transmitting data to a remote recipient. The example vehicles, systems and methods select the most appropriate medium or communication device for transmitting data based upon the type and/or content of the data and the current availability of different mediums or communication devices on the vehicle.

The example vehicles, systems, and methods evaluate data signals to be sent so as to categorize such data signals. The various data signals are assigned different data signal categories. Examples of different data signal categories include, but not limited to, operating information data signals regarding the vehicle (sometimes referred to as the vehicle's heartbeat), command/control data signals, video streaming data signals, real-time alert data signals (sometimes referred to as tickets), geographical data signals/files, CAN log data signals/files, and vehicle video data signals/files.

Operating information data signals indicate the current operational state of the vehicle such as its speed, direction, roll, pitch, battery charge level, distance covered, charging state, and the like. Such information data signals may originate from data sources such as wheel odometry sensors, accelerometers, gyroscopes, voltage level sensors, visual odometry provided by one or more cameras and the like.

Command/control data signals facilitate remote or automated control of the vehicle. Such data signals may comprise signals that confirm receipt of an incoming command or incoming control instructions. Such data signals may comprise signals that indicate an inability to perform a received command due to a particular circumstance. Such data signals may originate from data sources such as one or more controllers in the form of one or more microprocessors and associated software carried by the vehicle.

Video streaming data signals comprise packets or data signals reflecting or generated from image frames captured by one or more cameras, which serve as data sources, carried by the vehicle. Video streaming data signals are output at a frame rate or frequency to facilitate image frame streaming of different views from or with respect to the vehicle. For example, such video streaming data signals may comprise a stream of data signals originating from each of a forward-facing camera and the rear facing camera on the vehicle.

Real-time alerts/tickets comprise data signals that indicate a current or predicted future status that may need addressing. Such real-time alerts may serve as warnings or cautions. Such data signals may have differing degrees of severity ranging from alerts that need an immediate response to those alerts that notify an operator/manager of remedial action that should be taken when the vehicle reaches a base or ends its tasks. Examples of such alerts include, but are not limited to, a low battery charge alert, a low tire pressure alert, a rollover condition, an upcoming obstacle alert, a low supply of seed, herbicide, insecticide, fungicide, fertilizer or other consumable materials that are discharged or applied by the vehicle or an implement moved by the vehicle, a high-temperature warning, such as for a battery or electric motor, a high-voltage warning for a battery and/or electric motor, a fluid leak alert, a component breakage alert, or the like. Such alert data signals may originate directly from particular types of sensors that serve as data sources or may originate from controller/processors carried by the vehicle which evaluate data from sensors carried by the vehicle to identify the need for an alert.

Geographical coverage data signals may be in the form of a data file being transmitted, wherein the data file identifies the path taken by the vehicle. Such files may indicate the path of the vehicle along various crop, vine or orchard rows in a field, vineyard or an orchard. Such files may indicate not only the path of the vehicle, but the geographical area that was treated or interacted upon by the vehicle and/or implements/attachments carried by the vehicle. For example, such files may indicate those land regions to which fertilizer, herbicide, insecticide, fungicide, seed or other materials have been sprayed or otherwise applied. Such files may indicate those land regions which were tilled or cultivated by an implement pulled or pushed by the vehicle. Such files indicate those land regions from which crops or produce was harvested. Such signals may originate directly from sensors such as cameras, global positioning signals from global positioning satellite (GPS) systems, and various sensors with serve as data sources, or from controllers or processor carried by the vehicle which output such data signals based upon signals received from cameras, GPS systems and other sensors carried by the vehicle.

Controller Area Network (CAN) log data signals may be transmitted on a CAN bus of the vehicle. Such log files may indicate usage patterns, activity operations within the system, application or other device of the vehicle. Such data signals or files that may serve as a detected record of what has happened on the vehicle for troubleshooting or other purposes.

Vehicle video data signals or files comprise data signals that indicate a historical series of frames, a video, captured by a particular camera on the vehicle. For example, vehicle data signals/files may comprise five-minute (or other time duration) videos at various times as captured by a particular camera on the vehicle.

The example vehicles, systems and methods select a particular communication device carried by the vehicle for transmitting particular data signals based upon the category assigned to the particular data signals. For example, the vehicles may carry a cellular data communication device (such as Long-Term Evolution (LTE)) wireless standard communication device, a radio frequency communication device and a Wireless Fidelity (Wi-Fi) communication device. The example vehicles may carry a communications connection controller that selects from amongst the cellular data communication device (such as Long-Term Evolution (LTE)) wireless standard communication device, a radio frequency communication device and a Wireless Fidelity (Wi-Fi) communication device set of data signals based upon the respective availability of the different communication options and characteristics of the particular set of data signals.

In some examples, real-time communications or real time data sets, such as operating information data signals, command/control data signals, video streaming data signals and real-time alert data signals are given the highest priority for use of the cellular data communication device for transmission. Among such real-time communications, priority is given in the following order: operating information data signals over command/control data signals over video streaming data signals over real-time alert data signals. Prioritization means that data signals associate with a higher priority category may bump or replace data signals associated with a lower priority category and currently consuming the available bandwidth of the cellular data communications device. The bumped lower priority category data signals may then be transmitted using the radiofrequency communication device, if available. For example, if the available bandwidth or predetermined bandwidth (300 GB in one implementation) is currently being consumed for the transmission of real-time alert data signals, but an incoming set of data signals for operating info is received for transmission, the operating info data signals will bump the real-time alert data signals due to their higher priority, resulting in the operating info data signals being transmitted by the cellular data communications device and the bumped real-time alert data signals being transmitted by the radiofrequency communication device, if available. The radiofrequency communication device may transmit the data signals to the base station for further forwarding to the web portal. In some implementations, transmission by the radiofrequency communication device is not sufficiently fast for video streaming. In circumstances where video streaming data signals are bumped from cellular data communications device, the transmission of video streaming data may be paused, waiting for new bandwidth on the cellular data communication device to become available.

The communication connection controller may further be configured to first attempt to transmit non-real-time data signals, such as geographic vehicle coverage files, CAN log files and vehicle video files using the Wi-Fi communications device. Availability of the Wi-Fi communications device may depend on available bandwidth as well as the transmitter of the Wi-Fi communication device being with insufficient proximity to the remote Wi-Fi router, whether the router be part of a base station dedicated to receiving uploaded files and transmitting uploaded files to an operator/manager web portal or whether the router is a general customer Wi-Fi router that is not specifically dedicated to the vehicle or a fleet of vehicles, but is for general use by a person or customer. Use of the base station Wi-Fi router or the general customer Wi-Fi router may be dependent on proximity of the vehicle to the particular router. For example, such proximity may occur when the vehicle is in a storage shed or otherwise traveling or parked near or at the central site supporting the router. The router may communicate with a web portal or the operator/manager through Wi-Fi or a wide area network. In some implementations, the particular router may be configured to temporarily store files uploaded from the vehicle when the network is busy or bandwidth is limited, wherein such uploaded files may be transmitted to the web portal at low use times.

In circumstances where use of the Wi-Fi communications device is not available, such as when the vehicle is sufficiently distant the base station or other Wi-Fi router, the communications connection controller may attempt to transmit the non-real-time data signals or files using the cellular data communications device. In some implementations, each of the categories of real-time data signals have priority over the non-real-time data signals/files. As result, transmission of such non-real-time data signals/files may be bumped upon receipt of real-time communication signals by the communications connection controller. In circumstances where use of the cellular data communications device is not available (its bandwidth is being consumed by transmission of a higher priority set of data signals), such non-real-time communications may be transmitted using the radiofrequency communication device. The radiofrequency communication device may transmit the data signals to the base station four further forwarding to the web portal. Transmission of data signals by the radiofrequency communications device to the web portal or other remote recipient may be conducted on a first-in first out basis or may be performed based upon the above-described prioritization of the different categories of different sets of data signals from different data sources or communicating different content.

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two or more fluid transmitting volumes are connected directly to one another or are connected to one another by intermediate volumes or spaces such that fluid may flow from one volume into the other volume.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

For purposes of this, unless explicitly recited to the contrary, recitations reciting that signals “indicate” a value or state means that such signals either directly indicate a value, measurement or state, or indirectly indicate a value, measurement or state. Signals that indirectly indicate a value, measure or state may serve as an input to an algorithm or calculation applied by a processing unit to output the value, measurement or state. In some circumstances, signals may indirectly indicate a value, measurement or state, wherein such signals, when serving as input along with other signals to an algorithm or calculation applied by the processing unit may result in the output or determination by the processing unit of the value, measurement or state.

FIG. 1 is a diagram schematically illustrating portions of an example vehicle 1620 including or as part of an example network use optimization system 1622. Vehicle 1620 comprises a frame or chassis 1624 carrying data sources 1688-1 . . . 1628-n (collectively referred to as data sources 1628), a cellular data communication device 1630, a radiofrequency communication device 1632, a Wi-Fi communication device 1634, and a communication connection controller 1640. In some implementations, vehicle 1620 may be in the form of a self-propelled vehicle, such as a tractor, a truck, a passenger vehicle or the like. In some implementations, vehicle 1620 may be in the form of a vehicle that is pushed or pulled by another self-propelled vehicle, wherein the vehicle that is pushed or pulled by another self-propelled vehicle carries data source 1628, communication devices 1630, 1632 and 1634 and communication connection controller 1640. In some implementations, such components may be apportioned between multiple vehicles such as a self-propelled vehicle and secondary vehicle pushed or pulled by the self-propelled vehicle. For example, in some implementations, at least some of the data sources 1628 may be carried by an implement or other vehicle pushed or pulled by self-propelled vehicle in the form of a truck or tractor which carries the communication devices 1630, 1632, 1634 and which further carries the communication connection controller 1640.

Data sources 1628 comprise devices that generate and output data signals that provide data for transmission to an operator/manager 1642, such as an operator/manager connected to a web portal by smart phone, tablet computer or another interface. As discussed above, such data sources 1628 may have various forms. For example, data sources 1628 may comprise various sensors such as wheel encoders, cameras, potentiometers, voltage sensors, temperature sensors, contact switches and the like, that output signals for direct transmission. Data source 1628 may comprise processors that generate and output data signals that are based upon information received from such sensors. In some implementations, one or more of data source 1628 may be part of a larger computing device that also serves as the communication connection controller.

Cellular data communication device 1630 comprises a device configured to transmit data signals using a cellular mobile network distributed over land areas called cells. The network may be formed from cell towers. In one implementation, cellular data communication interface 1630 comprises a device configured to transmit data signals using “long-term evolution” standard or a later developed advanced standard. As compared to cell data communication device 1630 is generally a higher cost but faster long-range transportation mode.

Radiofrequency communication device 1632 comprise a device configured to transmit data signals using radio frequencies or radio signals. In the example illustrated, radiofrequency communication device 1632 communicates with a base station or base station Wi-Fi receiving device 1644 using such radio waves, wherein the base station 6044 communicates with the web portal 1642 using Wi-Fi network or a wide area network (WAN). In one example, radiofrequency communication device 1632 comprises a wireless transceiver LoRa RS232 RS485 433 MHz 5 W Long Distance 20 km PLC transceiver receiver 433 MHz Radio Modem such as EBYTE E90-DTU.

Wi-Fi communication device 1634 comprises a wireless transmitter or router configured to transmit data signals in a wireless fashion using a wireless Fidelity or wireless network such as the IEEE 802 protocol. In some implementations, Wi-Fi communication device 1634 comprises a LTE Cat 6 cellular router, such as an RUTX11 industrial cellular router commercially available from Teltonika Networks. As compared to cell data communication interface 1630 and radiofrequency communication device 1632, Wi-Fi communication interface 1634 has a lower transmission range and may be subject to bandwidth limitations. Wi-Fi communication device 1634 may provide lower costs transmission as compared to communication devices 1630 and 1632. In some implementations, Wi-Fi communication device 1634 may be omitted.

Base station 1644 is remote from vehicle 1620 and communicates with vehicle 1620 when vehicle 1620 is within sufficient proximity to base station 1644 or its router. Such Base station proximity may occur when the vehicle is in a storage shed or otherwise traveling or parked near or at the central site supporting the router. The router may communicate with a web portal or the operator/manager through Wi-Fi or a wide area network. In some implementations, base station 1644 may be configured to temporarily store files uploaded from the vehicle when the network is busy or bandwidth is limited, wherein such uploaded files may be transmitted to the web portal at later low use times.

Communication connection controller 1640 is carried by vehicle 1620 and comprises processing unit 1654 and memory 1656. Processing unit 1654 retrieves or obtains data signals, analyzes such data signals and may output control signals or further data based upon the retrieved data signals. Processing unit 16 carries out such operations based upon instructions contained in memory 1656.

Memory 1656 comprises a non-transitory computer-readable medium in the form of integrated circuits or software which include instructions configured to direct processor 64 to carry out at least the example method 1700 shown in FIG. 5. As indicated by block 1704 and FIG. 5, instructions in memory 1656 direct processing unit 1654 to receive data signals from one or more of data sources 1628. Such data signals may be raw data output by sensors, refined data output by sensors and/or data derived from or based upon such data signals. Such data signals may be further data, alerts or information which occurs in response to the data received from sensors or inputs from a local operator.

As indicated by block 1708, processing unit 1654 assigns a category to the data signals or assigns multiple different categories to different sets of data signals. Processing unit 1654 may assign such categories based upon the source from which the data signals originated. Processing unit 1654 may assign such categories based upon a flag or other identifier included with the data signals from the data source. Processing unit 1654 may assign such categories based upon a further analysis/processing of the content of the data signals by processing unit 1654 and based upon instructions contained in memory 1656.

As indicated by block 1712, processing unit 1654 evaluates the current availability of different communication options or channels provided by vehicle 1620. Such availability may depend upon the current operability of the individual communication options, the geographic location of vehicle 1620 and/or the current remaining amount of available bandwidth or capacity of a communications option not yet being utilized for other ongoing data signal transmissions.

As indicated by block 1716, controller 1640 selects from amongst various communication options for the transmission of a particular set of data signals based upon an availability of the various communication options identified in block 1712 and the data signal category assigned to the particular set of data signals in block 1708. For example, controller 1640 may automatically designate first particular categories of data signals, data signals having first particular types of content, to be transmitted by one particular type of communication option and may automatically designate second particular categories of data signals, data signals having second particular types of content, to be transmitted by another particular type of communication option.

In some implementations, distinct categories of data signals may be both be transmittable on a particular type of communication option, but wherein certain categories of data or signals have higher priorities or take preference over other categories of data signals. For example, data signals relating to real-time content may have a higher priority as compared to data signals transmitting historical content. Data signals communicating current real-time operational information, command-and-control confirmations, live video streaming and real-time alerts or tickets may have a higher priority as compared to historical data signal such as geographical vehicle coverage information, CAN log data signals or historical video files. In some implementations, controller 1640 may automatically bump (or bump in response to receiving operator confirmation) data signals having a lower priority category in favor of data signals having a higher priority category on a particular or preferred communication option. In the example illustrated, cellular data communication may be preferred over radiofrequency communication due to a higher speed, wherein Wi-Fi communication may be preferred over both cellular data communication and radio communication due to cost in circumstances where vehicle 1620 is within a Wi-Fi communication range.

As indicated by blocks 1718 and 1720, network use optimization system 1622 may be operable in one of two user selectable modes. As indicated by block 1718, in a first mode, controller 1640 may output its selected communication option (cellular data communication device, radiofrequency communication device for Wi-Fi communication device) as determined in block 1716 to an operator (via an operator interface such as a monitor, display screen or the like) for confirmation by the operator. In other words, controller 1640 may output a suggested transmission channel for the particular data set, wherein the operator must confirm and authorize the transmission using the selected channel. In some implementations, controller 1640 may notify the operator that a first particular set of data signals are being transmitted on a first communication option and that it recommends that the transmission of the first particular data signals be bumped in favor of a second set of data signals having a higher priority category. The bumped data signals would either be delayed for later transmission or transmitted via a less preferred communication option. Such bumping or switching would occur in response to an operator authorizing the switch. As indicated by block 1724, controller 1640 transmits the data signals with the selection following such operator confirmation.

As indicated by block 1720, in some implementations, controller 1640 may automatically, without operator intervention or authorization, initiate the transmission of the data signals on the selected communication channel or option (CDC device, RFC device or Wi-Fi device). In some implementations, controller 1640 may automatically bump (without operator intervention or authorization) data signals currently being transmitted by a particular communication channel or option in favor of different data signals which have a higher priority category. In some implementations, controller 1640 may automatically bump certain categories of data signals in favor of other categories of data signals, but for other categories of data signals may require operator authorization before such bumping or switching.

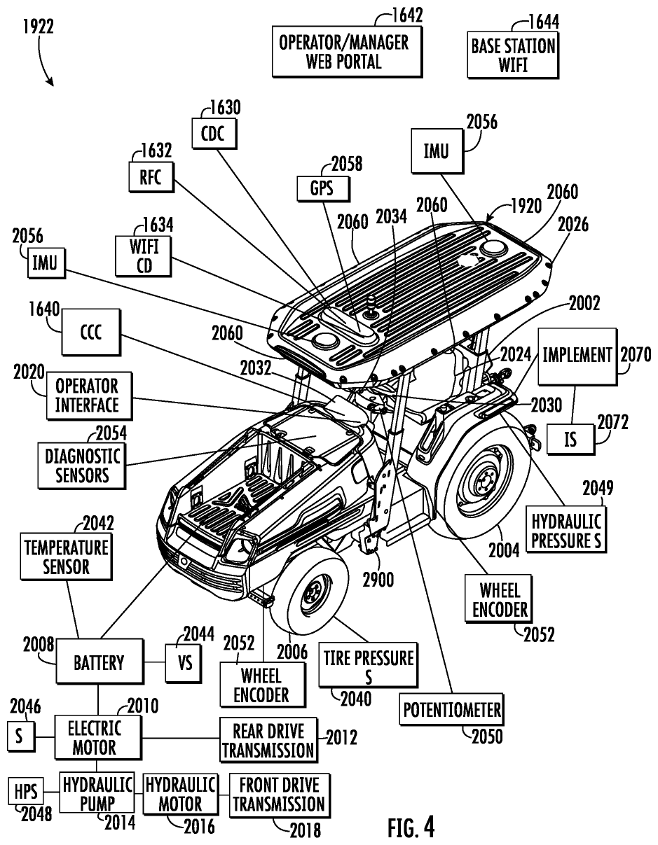

FIG. 3 is a flow diagram of an example method 1800 that may be carried out by network use optimization system 1622 shown and described above with respect to FIG. 4. As shown by blocks 1704 and 1708, as with method 1700, method 1800 involves controller 1640 receiving data signals from one of data sources 1628 and assigning a particular data signal category to the data signals.

In the example illustrated, controller 1640 may assign the data signals to one of seven example data signal categories: operating information 1801, command/control data signals 1802, video streaming signals 1803, real-time alert/messages 1804, geographic vehicle coverage data signals or files five, CAN log data signals or files 1806 and historical vehicle video data signals or files 1807.

### Operating Information Data

by the vehicle. Video streaming data signals 1803 are output at a frame rate or frequency to facilitate image frame streaming of different views from or with respect to the vehicle. For example, such video streaming data signals 1803 may comprise a stream of data signals originating from each of a forward-facing camera and the rear facing camera on the vehicle.

Real-time alerts/tickets 1804 comprise data signals that indicate a current or predicted future status that may need addressing. Such real-time alerts 1804 may serve as warnings or cautions. Such data signals may have differing degrees of severity ranging from alerts that need an immediate response to those alerts that notify an operator/manager of remedial action that should be taken when the vehicle reaches a base or ends its tasks. Examples of such alerts 1804 include, but are not limited to, a low battery charge alert, a low tire pressure alert, a rollover condition, an upcoming obstacle alert, a low supply of seed, herbicide, insecticide, fungicide, fertilizer or other consumable materials that are discharged or applied by the vehicle or an implement moved by the vehicle, a high-temperature warning, such as for a battery or electric motor, a high-voltage warning for a battery and/or electric motor, a fluid leak alert, a component breakage alert, or the like. Such alert data signals 1804 may originate directly from particular types of sensors that serve as data sources or may originate from former controller/processors carried by the vehicle which evaluate data from sensors carried by the vehicle to identify the need for an alert.

Geographical coverage data signals 1805 may be in the form of a data file being transmitted, wherein the data file identifies the path taken by the vehicle. Such files may indicate the path of the vehicle along various crop, fine or orchard rows network in a field. Such files 1805 may indicate not only the path of the vehicle, but the geographical area that was treated or interacted upon by the vehicle and/or implements/attachments carried by the vehicle. For example, such files 1805 may indicate those land regions to which fertilizer, herbicide, insecticide, fungicide, seed or other materials have been sprayed or otherwise applied. Such files may indicate those land regions which were tilled or cultivated by an implement pulled or pushed by the vehicle. Such files indicate those land regions from which crops to produce was harvested. Such data signals 1805 may originate directly from as cameras, global positioning signals from global positioning satellite (GPS) systems, and various sensors with service data sources, or from controllers or processor steering by the vehicle which output such data signals based upon signals received from cameras, GPS systems and other sensors carried by the vehicle.

Controller Area Network (CAN) log data signals 1806 may comprise a recorded log of signals transmitted on a CAN bus of the vehicle. Such log files 1806 may indicate usage patterns, activity operations within the system, application or other device of the vehicle. Such data signals or files 1806 may serve as a detected record of what has happened on the vehicle for troubleshooting or other purposes.

Vehicle video data signals or files 1807 comprise data signals that indicate a historical series of frames, a video, captured by a particular camera on the vehicle. For example, vehicle data signals/files 1807 may comprise five-minute (or other time duration) videos at various times as captured by a particular camera on the vehicle.

As indicated by decision blocks 1812 and 1814, controller 1640 evaluates the current availability of the different communication devices, cellular data communication device 1630, radiofrequency communication (RFC) device 1632 and Wi-Fi communication device 1634. For those data signals categorized as either a geographic vehicle coverage data signals 1805, CAN log files 1806 or vehicle video files 1807, communications connection controller 1641 determines whether Wi-Fi communication device 1634 is available. As indicated by block 1816, if the Wi-Fi communication device 1634 is available, if the Wi-Fi communication device 1634 is operating, is the within range of a Wi-Fi receiver, such as base station 1644, and is not already occupied or busy transmitting a different set of data signals, controller 1640 selects the Wi-Fi communication device 1634 for the transmission of the particular set of data signals. As discussed above with respect to block 1718 and 1720 and method 1700, controller 1640 may upload the set of data signals/files using the Wi-Fi device either automatically or upon receiving confirmation/authorization from an operator. signals 1801 indicate the current operational state of the vehicle such as its speed, direction, roll, pitch, battery charge level, distance covered, charging state, and the like. Such information data signals 1801 may originate from data sources such as wheel odometry sensors, accelerometers, gyroscopes, voltage level sensors, visual odometry provided by one or more cameras, and the like.

Command/control data signals 1802 facilitate remote or automated control of the vehicle. Such data signals 1802 may comprise signals that confirm receipt of an incoming command or incoming control instructions. Such data signals 1802 may comprise signals that indicate an inability to perform a received command due to a particular circumstance. Such data signal 1802 may originate from data sources such as one or more controllers in the form of one or more microprocessors and associated software carried by the vehicle.

Video streaming data signals 1803 comprise packets or data signals reflecting or generated from image frames captured by one or more cameras, which serve as data sources, carried

As indicated by arrow 1817, in response to the Wi-Fi communication device 1634 not being available, not operating, being without power, out of range of a Wi-Fi receiver such as base station 6044, or already in process of transmitting a different set of data signals or files, controller 1640 may determine whether the cellular data communication device 1630 is available per block 1814. In some implementations, in circumstances where the Wi-Fi communication by 1634 would otherwise be available but for the Wi-Fi communication by 1634 already being occupied with the transmission of a different set of data signals (where Wi-Fi communication device 1634 is within range of a Wi-Fi receiving device and is powered), controller 1640 may simply queue the set of data signals for transmission by the Wi-Fi communication device 1634 when the Wi-Fi communication device 1634 has completed the transmission of the other set of data signals.

In some implementations, controller 1640 may automatically queue data signals assigned to a first particular category of data signals and may automatically look to the availability of cellular data communication device 1630 for the transmission of data signals assigned to a second different particular category of data signals. For example data signals categorized as geographical vehicle coverage signals 1805 may not be queued but may instead be immediately transmitted by the CDC device 1630 or the RFC device 1632, if available, possibly providing for a timelier transmission. For example data signals categorized as an CAN log data signals 1806 or a vehicle video files 1807, timely transmission may not be as essential such that such signals may be queued. In some implementations, controller 1604 may determine an estimate for the remaining time needed to complete the transmission of the other set of data signals, wherein the decision to either queue (temporarily store) the newly received set of data signals or to alternatively attempt to transmit the newly received data signals by CDC device 1630 or RFC device 1632, if available, may be based upon comparing the estimated time to a predetermined threshold time/delay value. In some implementations, controller 1640 may prompt an operator for an input as to whether the operator wishes the set of data signals to be either queued for subsequent transmission by the Wi-Fi communication device 1634 or transmitted by the cellular data communication device 1630 or the radiofrequency communication device 1632, if available. In some implementations, the controller 6040 may notify the operator of the expected delay due to an ongoing transmission of another set of data signals, allowing the operator to determine whether or not the delays acceptable for queuing for later transmission by the Wi-Fi communication device 1634 or whether an attempt should be made to immediately transmit the newly received set of data signals using the CDC device 1630 or the RFC device 1632.

In some implementations, the expected size of the set of data signals, the size of the files, may be sufficiently large such that the transmission of such data signals by the cellular data communication device 1630 or the radiofrequency communication device 1632 may not be viewed as economical. In such circumstances, controller 40 may be constricted to transmit such data signals only using the Wi-Fi communication device 1634. In circumstances where the Wi-Fi communication device is already in use for the transmission of other sets of data signals, the current set of data signals may be queued. In circumstances where the Wi-Fi communication device 1634 is currently out of range of a Wi-Fi receiver, such as base station 1644, the different sets of Wi-Fi signal may be automatically queued or temporarily stored until vehicle 1620 is within range of the Wi-Fi receiving station. In some implementations, the operator may input commands to establish settings that identify what categories of data set are to only be transmitted when a Wi-Fi communication device 1634 is available or is within range of a Wi-Fi receiver. For example, in some implementations, geographic vehicle coverage data signals 1805, CAN log data signals 1806 and vehicle video files 1807 may be designated for transmission only using Wi-Fi communication device 1634. In such circumstances, transmission of such categories of data signals using the CDC device 1630 or the RFC device 1632 is not available.

As indicated by arrows 1818, certain categories of data signals are considered to be “real-time” data signals where the timeliness of the transmission of such data signals is more important. In the example illustrated, data signal categories 1801, 1802, 1803 and 1804 are considered to be real time data signals, having a higher priority to usage of the cellular data communication device 1630 than data signal categories 1805, 1806 and 1807. In some implementations, such data signal categories may have data signal categories 1801, 1802, 1803 and 8004 may also have higher priority to use of the Wi-Fi communication device 1634 when available. In the example illustrated, operating information data signals 1801 have a higher priority than the command/control data signals 1802. The command/control data signals 1802 have a higher priority than the video streaming data signals 1803. The video streaming data signals 1803 have a higher priority than the real-time alert data signals 1804. Such prioritization ensures that those data signals for which more timely transmission is beneficial have first access to the cellular data communication device 1630.

As indicated by block 1820, in response to the cellular data communication interface 630 being available, controller 1640 automatically proceeds with the transmission of the set of data signals using the CDC device 1630. As indicated 1822, in response to the speed not being available due to transmission bandwidth being fully utilized by another (prior) set of data signals controller 1640 determines whether the new set of data signals awaiting transmission have an assigned category with a higher priority than the category of the data signals currently being transmitted by the CDC device 1630.

As indicated by block 1824, in response to the new data signals awaiting transmission having a higher priority category than the category of the current set of data signals undergoing transmission by the CDC device 1630, controller 1640 determines whether RFC device 1632 is available for transmission of the current set of data signals undergoing transmission. As indicated by block 1826, in response to RFC device 1632 being available, controller 1640 automatically (or with confirmation from the operator) switches the current set of data signals undergoing transmission (now the prior data signals DS) to the RFC device 1632 for transmission, opening up bandwidth for CDC device 1630. As indicated by block 1830, controller 1640 proceeds with transmitting the new set of data signals awaiting transmission using the CDC device 1630.

As indicated by block 1832, in response to the RFC device 1632 not being available, such as when the RFC devices already transmitting a different set of data signals, controller 1640 ceases transmission of the prior data signals and stores such data signals for subsequent transmission as new data signals. The ceasing of transmission of the prior data signals makes additional bandwidth available for transmission using the CDC device. As indicated by block 1834, controller 1640 proceeds with transmitting the new set of data signals awaiting transmission using the CDC device 1630. Thereafter, as indicated by arrow 1835, controller 1640 returns to block 1814 to determine when CDC device 1630 is available for transmission of the prior data signals stored in block 1832.

As indicated by block 1840, in response to the category of the new set of data signals awaiting transmission not having a priority greater than the priority of the category of the current set of data signals undergoing transmission, controller 1640 checks or determines the availability of RFC device 1632. As indicated by block 1842, in response to a determination that RFC device 1632 is available, controller 1640 determines whether the set of data signals awaiting transmission belong to the video streaming category 1803. In the example illustrated, video streaming data signals are deemed as requiring use of the CDC device 1630 as use of the RFC device 1632 is too slow. In some implementations, blocks 1842 and 1848 may be omitted such that the transmission of data signals of the video streaming 1803 category may be transmitted using the RFC device 1632.

As indicated by block 1846, in response to the data signals awaiting transmission not belonging to the video streaming category 1803, controller 1640 proceeds with transmitting the data signals using RFC device 1632. As indicated by block 1848, in response to the data signals awaiting transmission being categorized as video streaming data signals, controller 1640 outputs control signals notifying the operator of the low bandwidth or insufficient bandwidth for the transmission of the video streaming signals. As indicated by block 1850, in response to both CDC device 1630 and RFC device 1632 being unavailable or in response to RFC device 1632 being available but wherein the data signals awaiting transmission comprise video streaming data signals, controller 1640 temporarily stores the data signals for subsequent transmission. As indicated by arrow 1853, controller 1640 continues to monitor availability of the CDC device 1630 as well as the RFC device 1632 for data signals that are not video streaming data signals.

FIG. 4 illustrates an example vehicle 1920 provided as part of an example network use optimization system 1922. Vehicle 1920 is in the form of a tractor comprising a chassis 2000, operator cab 2002, rear wheels 2004, front wheels 2006, battery 2008, electric motor 2010, rear drive transmission 2012, hydraulic pump 2014, hydraulic motor 2016, front drive transmission 2018, an operator interface 2020. Chassis 2000 comprises a frame for supporting the remaining components of vehicle 1920. Operator cab 2002 provides a location for an operator to reside on vehicle 1920. Operator cab 2002 may comprise a seat 2024 supported by chassis 2000 below roof 2026. In implementations where vehicle 1920 is completely automated, operator cab 2002 or at least seat 2024 may be omitted.

Rear wheels 2004 and front wheels 2006 serve as ground engaging propulsion or traction members for vehicle 1920. Wheels 2004 2006 are rotatably driven by torque supplied by electric motor 2010 which receives its power from battery 2008. In other implementations, wheels 2004 and/or wheels 2006 may be replaced with traction members in the form of tracks.

Battery 2008 comprises a rechargeable battery configured to supply sufficient amount of electrical charge for driving electric motor 2010 which supplies torque for driving at least rear wheels 2004 to propel vehicle 1920. Battery 2008 supplies electrical power to electric motor 2010 which supplies torque to rear drive transmission 2012. Rear drive transmission 2012 may comprise an arrangement of gears, transmission belts and the like to provide appropriate torque and speed control for the power being supplied to rear wheels 2004. Switching between different torques and speeds may be achieved in various fashions in response to inputs received from operator interface 2020.

In the example illustrated, electric motor 2010 further supplies torque to drive hydraulic pump 2014. Hydraulic pump 2014 may supply pressurized hydraulic fluid to various hydraulically driven implements or attachments of vehicle 1920. In the example illustrated, hydraulic pump 2014 further supplies pressurized hydraulic fluid to drive hydraulic motor 2016 which supplies torque to front drive transmission 2018. Front drive transmission 2018 transmits torque from hydraulic motor 2016 to front wheels 2006 to provide front drive or four-wheel-drive. The torque being supplied front wheels 2006 may be controlled to control lead and slip of vehicle 1920. In some implementations, hydraulic motor 2016 and front drive transmission 2018 may be omitted.

Operator interface 2020 comprises components of vehicle 1920 by which an operator, residing in operator cab 2002, or remotely located and in wireless communication with vehicle 1920, may provide inputs or instructions to vehicle 1920. Operator interface 2020 comprises steering wheel 2030, operator input console 2032 and touchscreen monitor 2034. Steering wheel 2030 comprises an input device by which an operator may provide steering input to vehicle 1920 when vehicle 1920 is operated in a manual mode or an operator assist automated mode. Operator input console 2032 may comprise various buttons, switches, slider bars, levers, touchpads, joysticks and the like. Touchscreen monitor 2034 may comprise a monitor by which an operator may view data and provide input or instructions via a touchscreen.

As shown by FIG. 4, vehicle 1920 further comprises multiple example data sources which are part of network use optimization system 1922. Such data sources may be in the form of: tire pressure sensors 2040, temperature sensors 2042, voltage sensors 2044, electric motor sensors 2046, hydraulic pressure sensors 2048 and 2049, potentiometers 2050, wheel encoders 2052, diagnostic sensors 2054, inertial measurement units 2056, global positioning satellite system (sensor) antenna and receivers 2058 (each of which is schematically illustrated) and cameras 2060. Tire pressure sensors 2040 (schematically illustrated) comprise sensors that output signals indicating the pneumatic pressure of wheels 2004, 2006.

Temperature sensors 2042 comprise one or more sensors configured to sense and output signals indicating the temperature of battery 2008 and/or Individual cells of battery 2008 (which may be a set or package of multiple individual batteries or cells/units. Voltage sensors 2044 comprise one or sensors to output signals indicating the voltage of battery 2008 or the voltages of individual cells, units or modules of battery 2008.

Electric motor sensors 2046 comprise sensors that output signals indicating operational parameters electric motor 2010, such as temperature, torque, consumed electrical charge or the like. Hydraulic pressure sensors 2048, 2049 comprise one or more sensors that sense and output signals indicating hydraulic pressure being output by hydraulic pump 1914 or experienced at various hydraulically powered consumers such as signals provided by hydraulic pressure sensors 2049.

Potentiometers 2050 comprise sensors to output signals indicating positioning of steering wheel 2030. In some implementations, potentiometers 2050 may further indicate the angular positioning of front wheels 2006. Wheel encoders 2052 comprise one or more sensors configured to output signals indicating a rotational speed of rear wheels 2004 and/or front wheels 2006.

Diagnostic sensors 2054 comprise various sensors configured to sense the operational performance of vehicle 1920. Such diagnostic sensors 2054 may comprise sensors that indicate the status of various switches, fuses, lights and the like for various electrical components of vehicle 1920.

Inertial measurement units 2056 comprise accelerometers and gyroscopes that may output signals indicating acceleration and/or movement of vehicle 1920 as well as its yaw, pitch and roll. In the example illustrated, vehicle 1920 comprises a pair of spaced inertial measurement units 2056 supported on roof 2026. In other implementations, vehicle 1920 may comprise inertial measurement units at other locations.

GPS 2050 comprises a GPS antenna and associated receiver for receiving signals and outputting signals that may directly indicate or that may be used to derive geographic coordinates of vehicle 1920.

Cameras 2060 serve as optical sensors configured to capture video and/or images of the environment or surroundings of vehicle 1920. Cameras 2060 may comprise two-dimensional cameras (monocular cameras) or stereo (3D) cameras. In the example illustrated, cameras 2060 are supported by roof 2026 and have forward, rearward, leftward and rightward fields of view. Such cameras may capture images or video of implement 2070. Such cameras may capture images or video of obstructions as well as the state or condition of crops, vines, trees or the like. In other implementations, vehicle 1920 may have a greater or fewer of such cameras. Such cameras may be located at additional or alternative locations.

As further shown by FIG. 4, vehicle 1920 may be attached to, push, or pull an implement 2070 (schematically illustrated). Such an implement may receive torque from vehicle 1920 through a power takeoff or may receive pressurized hydraulic fluid (supplied by hydraulic pump 2014 or an additional hydraulic pump carried by vehicle 1920) via hydraulic connection, wherein the hydraulic fluid drives a hydraulic driven component of implement 2070. Implement 2070 may further be movable to different heights or other positions such as with a three-point hitch. Examples of implement 1970, include, but are not limited to: a fertilizer spreaders prayer, an insecticide or herbicide spreader or sprayer, a pruning implement, a planter, a cultivator (disk or plow) and a mower.

In such implementations, implement 2070 may further include one or more implement sensors 2072. In such implementations, sensors 2072 may output signals indicating the current state or position of one or more components of implement 2070. In such implementations, the one or more sensors 2072 may transmit data signals to vehicle 1920 which are further transmitted to remote recipients by network use optimization system 1922. In some implementations, implement 2070 may comprise cameras which provide data signals to vehicle 1920 for use by vehicle 1920 and/or for transmission.

In addition to the above-described data sources, network use optimization system 1922 further comprises cellular data communication device 1630, radiofrequency communication device 1632, Wi-Fi communication device 1634 and communication connection controller 1640, each of which is described above. As described above, controller 1640 may carry out method 1700 or method 1800 described above, wherein data signals may be received from any of the above-described data sources or other data sources. As described above, controller 1640 may assign a data signal category to various data signals received from the data sources, may evaluate the current availability of CDC device 1630, RFC device 1632 and Wi-Fi device 1634. Controller 1640 may then select from such devices based upon the category and availability for transmission of the data signals. This may involve an output Ivy some of the selection for operator confirmation or involve automatic transmission of the selected data signals. The data signals may then be transmitted to a remote data recipient such as the operator/manager web portal 1642 or the base station Wi-Fi 1644, described above.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A network use optimization system comprising:
a vehicle;
at least one data source carried by the vehicle and configured to output data signals;
a cellular data communication device carried by the vehicle;
a radio frequency communications device carried by the vehicle; and
a communication connection controller carried by the vehicle and configured to:
receive the data signals from the at least one data source;
assign a data signal category to the data signals;
evaluate a current availability of each of the cellular data communications device and the radio frequency communications device;
select one of the cellular data communications (CDC) device and the radio frequency communications (RFC) device for transmission of the data signals based on the current availability of each of the cellular data communications device and the radio frequency communications device and the category assigned to the data signals; and
output the selection to a person for confirmation and in response to a received confirmation, transmit the data signals using the selection or automatically transmit the data signals using the selection.

2. The network use optimization system of claim 1, further comprising a wireless fidelity (WI-FI) communication device carried by the vehicle, wherein the communication connection controller is configured to select one of the CDC device, the RFC device and the WI-FI communications device for transmission of the data signals based on the current availability of each of the CDC device, the RFC device, the WI-FI communications device, and the data signal category assigned to the data signals.

3. The network use optimization system of claim 2, wherein the communications connection controller is configured to prioritize use of the Wi-Fi communications device, once available, over use of the CDC device and the RFC device.

4. The network use optimization system of claim 1, wherein the communications connection controller is configured to automatically transmit the data signals using the selection.

5. The network use optimization system of claim 1, wherein the communications connection controller is configured to prioritize consumption of any availability of the CDC device over consumption of any availability of the RFC device for data signals having an assigned category of operating information, command control, real-time alert or streaming video.

6. The network use optimization system of claim 5, wherein the communications connection controller is configured to prioritize different data signal categories (1) operating information over (2) command control over (3) real-time alert over (4) streaming video for consumption of any availability of the CDC device.

7. The network use optimization system of claim 1, wherein the communications connection controller is configured to prioritize consumption of any availability of the CDC device over consumption of any availability of the RFC device for data signals having an assigned category of geographic vehicle coverage file, CAN log file, and vehicle video files.

8. The network use optimization system of claim 7, wherein the communications connection controller is configured to prioritize data signal having an assigned category geographic vehicle coverage file over data signals having an assigned category of CAN log file over data signals having an assigned category of vehicle video files, for consumption of any availability of the CDC device.

9. The network use optimization system of claim 1, wherein the communications connection controller is configured to prioritize data signals having an assigned category of operating information, command control, real-time alert or streaming video over data signals having an assigned category of geographic vehicle coverage file, CAN log file, and vehicle video files, for consumption of any availability of the CDC device.

10. The network use optimization system of claim 1, wherein the availability of the CDC device is based upon a predetermined bandwidth threshold.

11. The network use optimization system of claim 2 further comprising a base station Wi-Fi receiving device remote from the vehicle to receive the data signals transmitted by the Wi-Fi communications device, the Wi-Fi receiving device connected to a Wi-Fi network.

12. The network use optimization system of claim 11, wherein the base station Wi-Fi receiving device is configured to store the data signals received from the Wi-Fi communications device and is configured to forward the data signals based upon usage of the Wi-Fi network.

13. The network use optimization system of claim 11, wherein the availability of the Wi-Fi communications device is based upon a proximity of the Wi-Fi communications device and the base station Wi-Fi receiving device.

14. A network use optimization system comprising:
a communication connection controller for being carried by a vehicle and configured to:
receive data signals from at least one data source;
assign a data signal category to the data signals;
evaluate a current availability of each of a cellular data communications device and a radio frequency communications device carried by the vehicle;
select one of the cellular data communications (CDC) device and the radio frequency communications (RFC) device for transmission of the data signals based on the current availability of each of the cellular data communications device and the radio frequency communications device and the category assigned to the data signals; and
output the selection to a person for confirmation and in response to a received confirmation transmit the data signals using the selection, or automatically transmit the data signals using the selection.

15. The network use optimization system of claim 14, wherein the communication connection controller is configured to select one of the CDC device, the RFC device and a WI-FI communications device carried by the vehicle for transmission of the data signals based on the current availability of each of the CDC device, the RFC device, the WI-FI communications device, and the data signal category assigned to the data signals.

16. The network use optimization system of claim 15, wherein the communications connection controller is configured to prioritize use of the Wi-Fi communications device, once available, over use of the CDC device and the RFC device.

17. The network use optimization system of claim 12, wherein the communications connection controller is configured to automatically transmit the data signals using the selection.

18. The network use optimization system of claim 12, wherein the communications connection controller is configured to prioritize consumption of any availability of the CDC device over consumption of any availability of the RFC device for data signals having an assigned category of operating information, command control, real-time alert or streaming video.

19. The network use optimization system of claim 18, wherein the communications connection controller is configured to prioritize different data signal categories (1) operating information over (2) command control over (3) real-time alert over (4) streaming video for consumption of any availability of the CDC device.

20. The network use optimization system of claim 12, wherein the communications connection controller is configured to prioritize consumption of any availability of the CDC device over consumption of any availability of the RFC device for data signals having an assigned category of geographic vehicle coverage file, CAN log file, and vehicle video files.
